(19) United States
(12) Patent Application Publication
(10) Pub. No.: US 2017/0320360 A1
(43) Pub. Date: Nov. 9, 2017

(54) Pneumatic Tire

(71) Applicant: The Yokohama Rubber Co., Ltd, Minato-ku, Tokyo (JP)

(72) Inventor: Takahiro Yamakawa, Hiratsuka-shi, Kanagawa (JP)

(21) Appl. No.: 15/531,721

(22) PCT Filed: Nov. 25, 2015
(86) PCT No.: PCT/JP2015/083072

§ 371 Date: May 30, 2017

(30) Foreign Application Priority Data
Dec. 1, 2014 (JP) 2014-243015

(51) Int. Cl. B60C 11/03; B60C 11/12

(52) U.S. Cl. CPC B60C 11/0306; B60C 11/1236; B60C 11/0304; B60C 2011/0365; B60C 2011/0353

(57) ABSTRACT

A pneumatic tire includes four main grooves defining a central land portion, intermediate land portions, and outer land portions. Compound grooves including lateral grooves communicate with the main groove and terminate inside a land portion, and including sipes extending from the lateral grooves to the main groove, are formed at an interval in the tire-circumferential direction in the central land portion or an intermediate land portion. An opening direction of the lateral grooves relative to the main grooves alternatingly reverses in the tire circumferential direction. The lateral grooves include a broad width portion that opens to the main groove and extends at a constant groove width, and a narrow width portion positioned between the broad width portion and the sipe and extends at a constant groove width narrower than the broad width portion.

### TECHNICAL FIELD

The present technology relates to a pneumatic tire and particularly relates to a pneumatic tire with improved snow performance and wear resistance performance.

### BACKGROUND ART

All-season pneumatic tires that are presumably used throughout the year on dry road surfaces, wet road surfaces, snow-covered road surfaces, and the like require, in addition to regular dry performance and wet performance, snow performance (steering stability performance on snow-covered road surfaces, for example). Additionally, because such pneumatic tires can be used on various road surfaces as described above, the tires require wear resistance performance for long-term use.

Examples of possible methods for improving snow performance include providing a large number of lateral grooves that extend in the tire width direction to secure edge components. Nevertheless, when a large number of lateral grooves are provided, land portion rigidity decreases, making it difficult to achieve excellent wear resistance performance. In order to achieve good snow performance and wear resistance performance in a compatible manner, Japanese Unexamined Patent Application Publication No. 2011-183884A, for example, proposes providing a large number of lateral grooves that extend in the tire width direction to a plurality of rows of land portions defined by a plurality of main grooves extending in a circumferential direction, thereby securing a large number of edge components and improving snow performance. Japanese Unexamined Patent Application Publication No. 2011-183884A further proposes adjusting a shape, a groove width, a disposition, and the like of the lateral grooves to increasingly reduce the number of lateral grooves as a distance to a tire equator decreases, thereby securing land portion rigidity near the tire equator and maintaining wear resistance performance.

Nevertheless, simply adjusting the shape, the groove width, the disposition, and the like of the lateral grooves does not always achieve good snow performance and wear resistance performance in a highly compatible manner, and thus further improvement is required.

### SUMMARY

The present technology provides a pneumatic tire with improved snow performance and wear resistance performance.

A pneumatic tire according to the present technology includes four main grooves that extend in a tire circumferential direction on a tread portion, and five rows of land portions defined by these main grooves. In such a pneumatic tire, when, among the four main grooves, a pair of main grooves disposed on both sides of a tire equator serve as inner main grooves, and the main grooves disposed on an outer side in a tire width direction of the inner main grooves serve as outer main grooves, the land portion positioned between the pair of inner main grooves serves as a central land portion, the land portions positioned between the inner main groove and the outer main grooves serve as intermediate land portions, and the land portions positioned on an outer side in the tire width direction of the outer main grooves serve as outer land portions. A plurality of compound grooves, each including a lateral groove having a first end that communicates with a main groove on one side thereof and a second end that terminates inside a land portion, and further including a sipe that extends from the second end of the lateral groove to a main groove on the other side thereof, are formed at an interval in the tire circumferential direction in any one of the central land portion and the intermediate land portions. The compound grooves are disposed so that an opening direction of the lateral grooves relative to the main grooves alternatingly reverses in the tire circumferential direction, and the lateral grooves each include a broad width portion that opens to a main groove and extends at a constant groove width, and a narrow width portion that is positioned between the broad width portion and the sipe and extends at a constant groove width narrower than that of the broad width portion.

According to the present technology, it is possible to achieve excellent snow performance by an edge effect of the compound grooves. At this time, the compound grooves each include a lateral groove having the first end that communicates with a main groove on one side, and the second end that terminates inside a land portion, and further includes the sipe that extends from the second end of the lateral groove to a main groove on the other side thereof. With the existence of the sipe, the land portions are substantially not divided, making it possible to maintain higher land portion rigidity compared to when conventional lateral grooves that divide the land portions are provided, and thus adequately maintain wear resistance performance. Further, the lateral grooves each include a broad width portion and a narrow width portion, and thus the compound grooves each have a structure in which the groove width decreases in a stepped manner from the first end toward the second end as a whole, making it possible to alleviate stress concentration and effectively increase wear resistance performance. Furthermore, the plurality of lateral grooves formed in the same land portion do not all open toward a main groove on the same side, but rather the opening direction of the plurality of lateral grooves alternatingly reverses in the tire circumferential direction, thereby distributing in the width direction of the land portion the areas within the land portion where land portion rigidity decreases due to the lateral grooves, and thus making it possible to effectively increase wear resistance.

According to the present technology, preferably the compound grooves are formed in the central land portions as well as each of the intermediate land portions. This makes it possible to more effectively achieve good snow performance and low wear resistance performance in a compatible manner.

At this time, preferably an inclination direction of the plurality of compound grooves formed in any one of the central land portion and the intermediate land portions differs from an inclination direction of the plurality of compound grooves formed in the other of the central land portion and the intermediate land portions. More preferably, the inclination direction of the compound grooves differs between the central land portion and the intermediate land portions. This decreases direction heteroscedasticity during steering, making it possible to improve snow performance.

According to the present technology, preferably a circumferential-direction auxiliary groove having a groove width that is smaller than that of the main grooves and extending in the tire circumferential direction is provided to at least one of the land portions in which the compound grooves are formed. With the circumferential-direction auxiliary groove thus provided, edge components resulting from the circumferential-direction auxiliary groove are also obtained, making it possible to further improve snow performance.

According to the present technology, preferably a ratio Wa/Wb of a groove width Wa of the broad width portion to a groove width Wb of the narrow width portion is within a range of from 1.2 to 3.0, and a ratio Wb/Ws of the groove width Wb of the narrow width portion to a groove width Ws of the sipe is within a range of from 1.2 to 5.0. The ratios Wa/Wb and Wb/Ws of the groove widths of each portion of the compound groove are thus set, making it possible to achieve good snow performance and wear resistance performance in a highly compatible manner. Moreover, the groove width of each portion is measured at a portion where groove walls on both sides form a line on the tread surface.

According to the present technology, preferably a ratio La/Lr of a width Lr of the land portion in which the compound grooves are formed to a tire width direction length L of the broad width portion satisfies the relationship 0.4≦La/Lr≦0.7, a ratio Lb/Lr of the width Lr to a tire width direction length Lb of the narrow width portion satisfies the relationship 0.15≦Lb/Lr≦0.3, and a ratio Ls/Lr of the width Lr to a tire width direction length Ls of the sipe satisfies the relationship 0.15≦Ls/Lr≦0.3. The broad width portion, the narrow width portion, and the tire width direction length of the sipe that constitute the compound groove are thus set, strengthening the achievement of good snow performance and wear resistance performance in a well-balanced manner. Moreover, the tire width direction length of each portion of the compound groove is the length when each portion of the compound groove is projected in the tire circumferential direction. Further, a boundary between the broad width portion and the narrow width portion is a tire width direction center of the portion where the groove width changes.

Moreover in the present technology, the sipe is a fine groove having a groove width of 1.5 mm or less, and can be regarded as substantially not dividing a land portion even when formed across the land portion. Further, the dimensions and the angles of the compound groove (the broad width portion, the narrow width portion, and the sipe) are measured on the basis of a center line of each portion.

### BRIEF DESCRIPTION OF DRAWINGS

FIG. 1 is a meridian cross-sectional view of a pneumatic tire according to an embodiment of the present technology.

FIG. 2 is a front view illustrating a tread surface of the pneumatic tire according to the embodiment of the present technology.

FIG. 3 is a magnified front view illustrating a compound groove of the pneumatic tire according to the present technology.

FIG. 4 is an explanatory diagram illustrating a structure of the compound groove of a pneumatic tire of a comparative example.

FIG. 5 is an explanatory diagram illustrating a structure of the compound groove according to another embodiment of the present technology.

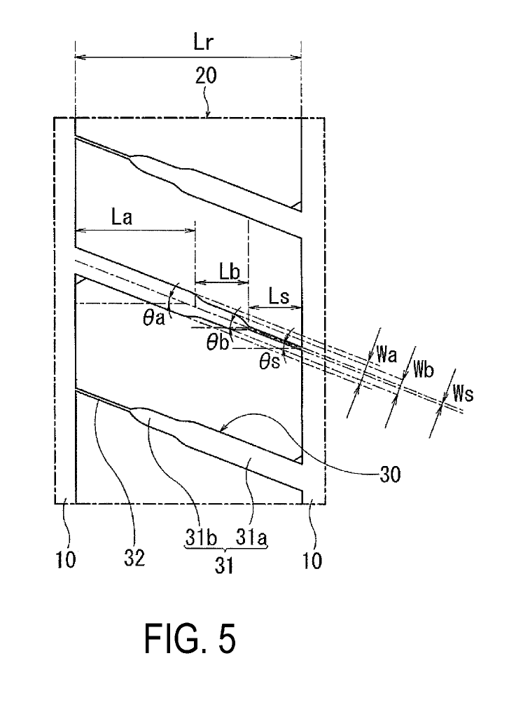

FIG. 6 is an explanatory diagram illustrating the structure of the compound groove of the pneumatic tire of the comparative example.

FIG. 7 is a front view illustrating a tread surface of the pneumatic tire according to another embodiment of the present technology.

FIG. 8 is an explanatory diagram illustrating an example of a groove formed in a conventional pneumatic tire.

### DETAILED DESCRIPTION

Embodiments of the present technology are described in detail below with reference to the accompanying drawings.

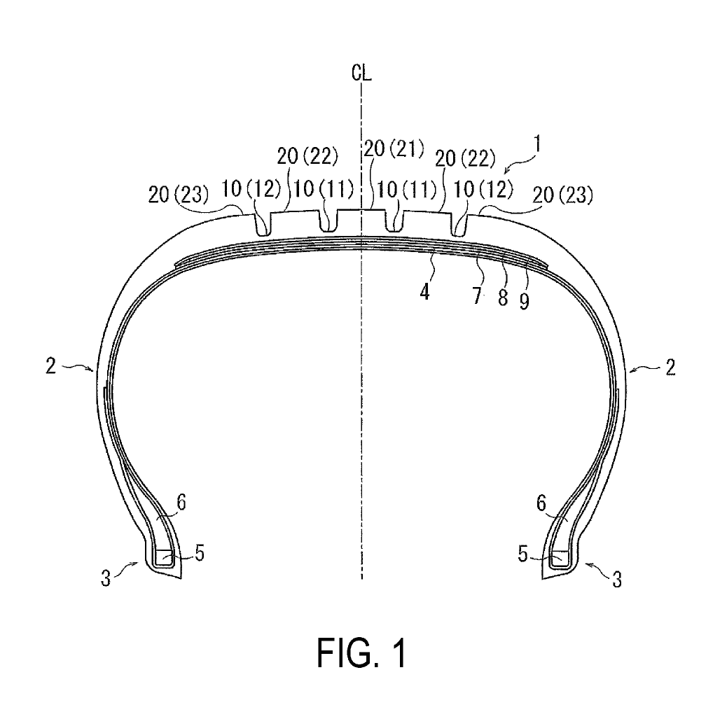

Reference sign CL in FIG. 1 denotes the tire equator. A pneumatic tire of the present technology is provided with a tread portion 1 extending in a tire circumferential direction to form a ring shape, a pair of sidewall portions 2 disposed on both sides of the tread portion 1, and a pair of bead portions 3 disposed on inner sides in a tire radial direction of the sidewall portions 2. One carcass layer 4 extends between the left-right pair of bead portions 3. The carcass layer 4 includes a plurality of reinforcing cords extending in the tire radial direction, and is folded back around a bead core 5 disposed in each bead portion 3 from a vehicle inner side to a vehicle outer side. Additionally, bead fillers 6 are disposed on the periphery of the bead cores 5, and each bead filler 6 is enveloped by a main body portion and a folded back portion of the carcass layer 4. In the tread portion 1, a plurality of belt layers 7 (two layers in FIG. 1) are embedded on the outer circumferential side of the carcass layer 4. Each of the belt layers 7 includes a plurality of reinforcing cords inclined with respect to the tire circumferential direction, and the reinforcing cords are disposed so as to intersect each other between the layers. In the belt layers 7, an inclination angle of the reinforcing cords with respect to the tire circumferential direction is set within a range of from, for example, 10° to 40°. A belt reinforcing layer 8 is further disposed on the outer circumferential side of the belt layers 7. The belt reinforcing layer 8 includes organic fiber cords oriented in the tire circumferential direction. In the belt reinforcing layer 8, the angle of the organic fiber cords with respect to the tire circumferential direction is set, for example, to from 0° to 5°.

The present technology may be applied to such a general pneumatic tire, however, the cross-sectional structure thereof is not limited to the basic structure described above.

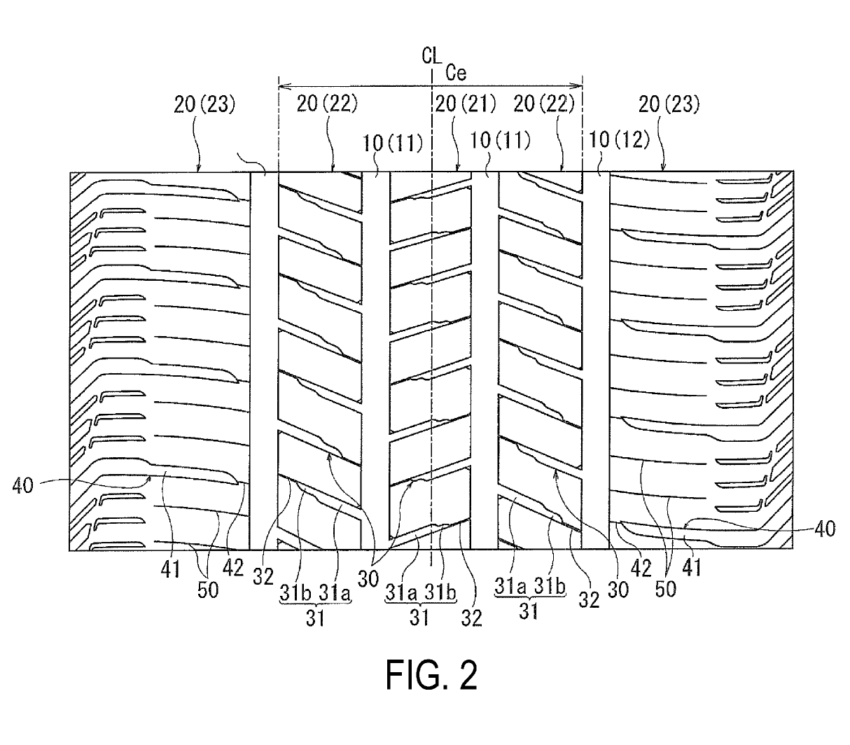

Four main grooves 10 are formed in the tread portion 1 in the embodiment illustrated in FIG. 2. These four main grooves 10 include a pair of inner main grooves 11 disposed on both sides in the tire width direction of the tire equator CL, and outer main grooves 12 disposed on the outer side in the tire width direction of the inner main grooves 11. In other words, a pair of the outer main grooves 12 extending in the tire circumferential direction is formed on both sides in the tire width direction of the tire equator CL, and two of the inner main grooves 11 extending in the tire circumferential direction are formed in a region (hereinafter, referred to as the “center region Ce”) on the inner side in the tire width direction of this pair of outer main grooves 12.

In the tread portion 1, five rows of land portions 20 extending in the tire circumferential direction are defined in the tread portion 1 by the four main grooves 10 (two inner main grooves 11 and two outer main grooves 12). Given that, among these five rows of land portions, the land portion 20 defined between the two inner main grooves 11 serves as a central land portion 21, the land portions 20 defined between the inner main groove 11 and the outer main groove 12 serve as intermediate land portions 22, and the land portions 20 defined on the outer side of the outer main grooves 12 in the tire width direction serve as the outer main grooves 23, the central land portion 21 and the intermediate land portions 22 are positioned inside the center region Ce. In the present technology, a compound groove 30, having the structure defined later, is provided in at least one of the three rows of land portions (the central land portion 21 and the intermediate land portions 22) positioned inside this center region Ce, and the structure of the outer land portions 23 is not particularly limited.

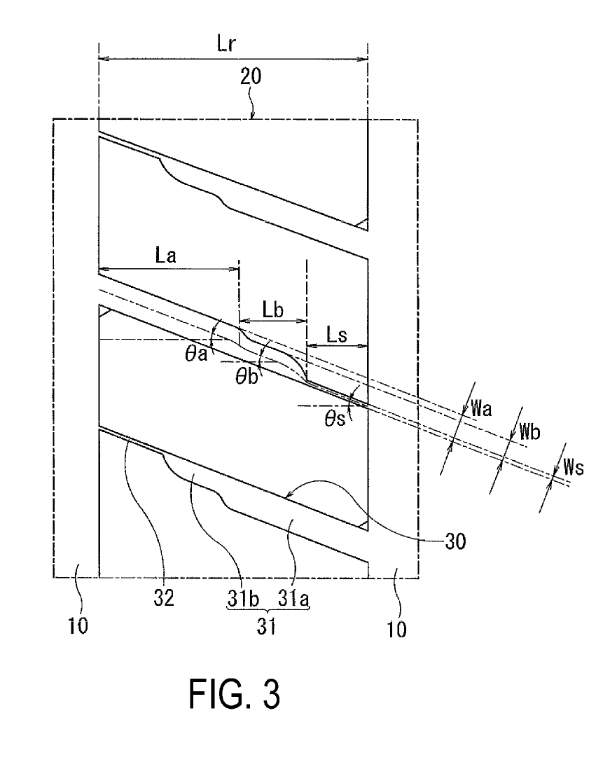

A plurality of the compound grooves 30 extending in the tire width direction are formed at an interval in the tire circumferential direction in the central land portion 21 and the intermediate land portions 22, as illustrated in FIG. 2. Each of the compound grooves 30, as magnified in FIG. 3, includes a lateral groove 31 having a first end that communicates with the main groove 10 on one side thereof and a second end that terminates inside the land portion 20, and further includes a sipe 32 that extends from the second end of this lateral groove 31 to the main groove 10 on the other side thereof. Moreover, in the compound groove 30 formed in the central land portion 21, the first end of the lateral groove 31 communicates with the inner main groove 11 on one side thereof, the second end of the lateral groove 31 terminates inside the central land portion 21, and the sipe 32 extends from the first end of the lateral groove 31 to the inner main groove 11 on other side thereof. On the other hand, in the compound groove 30 formed in the intermediate land portions 22, the first end of the lateral groove 31 communicates with one of the inner main groove 11 and the outer main groove 12, the second end of the lateral groove 31 terminates inside the intermediate land portion 22, and the sipe 32 extends from the second end of the lateral groove 31 to the other of the inner main groove 11 and the outer main groove 12. Abroad width portion 31a that opens to the main groove 10 and extends at a constant groove width, and a narrow width portion 31b that is positioned between the broad width portion 31a and the sipe 32 and extends at a constant groove width narrower than that of the broad width portion 31a are formed in each of the lateral grooves 31. As a result, the compound groove 30, as a whole, has a shape having a groove width that narrows in a stepped manner from the opening portion relative to the main groove 10 on one side thereof toward the communicating portion (arrival point at the sipe 32) relative to the main groove 10 on the other side thereof.

At this time, according to the embodiment illustrated in FIG. 3, a groove wall on one side of the compound groove 30 in the tire circumferential direction forms a straight line on the tread surface, and a groove wall on the other side of the compound groove 30 in the tire circumferential direction forms a non-straight line that bends in a stepped manner on the tread surface. The non-straight line that bends in a stepped manner is formed by smoothly connecting the groove wall of the broad width portion 31a that forms a straight line on the tread surface, the groove wall of the narrow width portion 31b that forms a straight line on the tread surface, and the groove wall of the connecting portion that inclines with respect to the groove walls of the broad width portion 31a and the narrow width portion 31b of the tread surface and connects the broad width portion 31a and the narrow width portion 31b, and further connecting the groove wall of the sipe 32 that forms a straight line on the tread surface to the terminating end where the groove width of the narrow width portion 31b gradually narrows and terminates.

The plurality of compound grooves 30 formed inside one row of land portions 20 are disposed so that an opening direction of the lateral grooves 31 with respect to the main grooves 10 alternatingly reverses in the tire circumferential direction. That is, the compound groove 30 adjacent in the tire circumferential direction to another compound groove 30 in which the lateral groove 31 communicates with the main groove 10 on one side thereof has a structure in which the lateral groove 31 communicates with the main groove 10 on the other side thereof. Specifically, in the plurality of compound grooves 30 formed in the central land portion 21, the opening direction of the lateral grooves 31 with respect to one of a pair of inner main grooves 11 are disposed so as to alternatingly reverse in the tire circumferential direction, and the compound groove 30 adjacent in the tire circumferential direction to another compound groove 30 in which the lateral groove 31 communicates with the inner main groove 11 on one side thereof has a structure in which the lateral groove 31 communicates with the inner main groove 11 on the other side thereof. Further, in the plurality of compound grooves 30 formed in the central land portion 22, the opening direction of the lateral grooves 31 with respect to one of the inner main groove 11 and the outer main groove 12 are disposed so as to alternatingly reverse in the tire circumferential direction, and the compound groove 30 adjacent in the tire circumferential direction to another compound groove 30 in which the lateral groove 31 communicates with one of the inner main groove 11 and the outer main groove 12 has a structure in which the lateral groove 31 communicates with the other of the inner main groove 11 and the outer main groove 12.

The compound grooves 30 adjacent in the tire circumferential direction are disposed so that either the groove walls that form straight lines or the groove walls that form non-straight lines described above face each other. As a result, in each of the land portions 20 in which the compound grooves 30 are formed, there is defined a portion that is surrounded by each of the groove walls on the inner side in the tire width direction of the main groove 10 adjacent to the land portion 20 and the two groove walls that form straight lines of the compound groove 30, forming a parallelogram on the tread surface.

While the compound groove 30 has a shape in which the groove width changes in a stepped manner as described above, given Wa as the groove width of the broad width portion 31a, Wb as the groove width of the narrow width portion 31b, and Ws as the groove width of the sipe 32, each of the compound grooves has a ratio Wa/Wb of the groove width Wa to the groove width Wb set within a range of from 1.2 to 3.0, for example, and a ratio Wb/Ws of the groove width Wb to the groove width Ws set within a range of from 1.2 to 5.0, for example.

Further, while each of the compound grooves 30 includes three portions (the broad width portion 31a, the narrow width portion 31b, and the sipe 32) as described above, given Lr as the width of the land portion 20 in which the compound grooves 30 are formed, La as the tire width direction length of the broad width portion 31a, Lb as the tire width direction length of the narrow width portion 31b, and Ls as the tire width direction length of the sipe 32, the ratio La/Lr satisfies the relationship 0.4≦La/Lr≦0.7, for example, the ratio Lb/Lr satisfies the relationship 0.15≦Lb/Lr≦0.3, for example, and the ratio Ls/Lr of the width Lr to the tire width direction length Ls of the sipe 32 satisfies the relationship 0.15≦Ls/Lr≦0.3, for example.

In the embodiment illustrated in FIGS. 2 and 3, the compound groove 30 extends on an incline in the tire width direction and, given θa as the inclination angle of the broad width portion 31a with respect to the tire width direction, θb as the inclination angle of the narrow width portion 31b with respect to the tire width direction, and θs as the inclination angle of the sipe 32 with respect to the tire width direction, the inclination angles θa, θb, θs are preferably from 0° to 30°, and more preferably from 17° to 24°. That is, the compound groove 30, as a whole, inclines at an angle of 30° or less. Further, the lateral groove 31 and the sipe 32 preferably extend in the same direction, and the angle difference between the inclination angle θb and the inclination angle θs (or the angle difference between the inclination angle θa and the inclination angle θs) is, for example, from 0° to 20°, and more preferably from 0° to 10°. Moreover, in the embodiment illustrated in FIG. 2, the inclination direction of the compound grooves 30 formed in the central land portion 21 and the inclination direction of the compound grooves 30 formed in the intermediate land portions 22 are opposite.

In contrast to the central land portion 21 and the intermediate land portions 22 described above, a plurality of compound grooves 40 extending in the tire width direction are formed at an interval in the tire circumferential direction in the outer land portions 23, as illustrated in FIG. 2. Note that, unlike the above-described compound grooves 30 formed in the central land portion 21 and the intermediate land portions 22, each of the compound grooves 40 formed in the outer land portions 23 includes a lateral groove 41 having a first end that terminates inside the land portion 20 (outer land portion 23) without reaching the main groove 10 (the outer main groove 12), and a second end that opens to the outer side in the tire width direction, and further includes a sipe 42 that extends from the first end of this lateral groove 41 to the main groove 10 (outer main groove 12). In addition to this compound groove 40, each of the outer land portions 23 is provided with a plurality (two in FIG. 2) of sipes 50 that are disposed in portions defined by the compound grooves 40 and extend in the tire width direction.

With the compound grooves 30 having the above-described structure thus provided to the central land portion 21 and the intermediate land portions 22 positioned in the center region Ce, it is possible to achieve excellent snow performance by the edge effect on the basis of the compound grooves 30. At this time, each of the compound grooves 30 includes the sipe 32, making it possible to maintain high rigidity in the land portion 20 in which the compound grooves 30 are formed, without substantially dividing the land portion 20. This makes it possible to achieve snow performance while maintaining wear resistance performance. At this time, the compound grooves 30 each have a shape in which the groove width changes in a stepped manner from the first end toward the second end as described above, making it possible to alleviate stress concentration and effectively increase wear resistance performance. Further, as described above, the lateral grooves 31 do not all open toward the main groove on the same side, but rather the opening direction of the lateral grooves 31 alternatingly reverses in the tire circumferential direction, thereby distributing in the tire width direction the areas within the land portion 20 where provision of the lateral grooves 31 causes a reduction in rigidity, and thus making it possible to effectively increase wear resistance performance.

Each of the compound grooves 30 is required to include the lateral groove 31 and the sipe 32, as described above. When the grooves formed in the land portion 20 and extending in the tire width direction include only the lateral groove 31 formed by the broad width portion 31a and the narrow width portion 31b, and not the sipe 32 extending from the terminating portion of the lateral groove 31 to the main groove 10, adequate snow performance cannot be achieved.

While, according to the embodiment illustrated in FIGS. 2 and 3, the groove wall on one side of the compound groove 30 in the tire circumferential direction forms a straight line on the tread surface, and the groove wall on the other side of the compound groove 30 in the tire circumferential direction forms a non-straight line that bends in a stepped manner on the tread surface, it is important in the present technology that the groove width of the compound groove 30 changes in a stepped manner, and thus the groove walls on both sides of the compound groove 30 may form non-straight lines that bend in a stepped manner on the tread surface. Note that, with the groove wall on one side formed into a straight line, it is possible to eliminate areas of change in the groove wall on the one side, strengthening the improvement of wear resistance performance. In particular, with the compound grooves 30 adjacent in the tire circumferential direction disposed so that the above-described groove walls that form straight lines or groove walls that form non-straight lines face each other as described above, an area defined in a parallelogram shape inside the land portion 20 is produced, making it possible to improve rigidity as a result of this area, and thus strengthen the improvement of wear resistance performance.

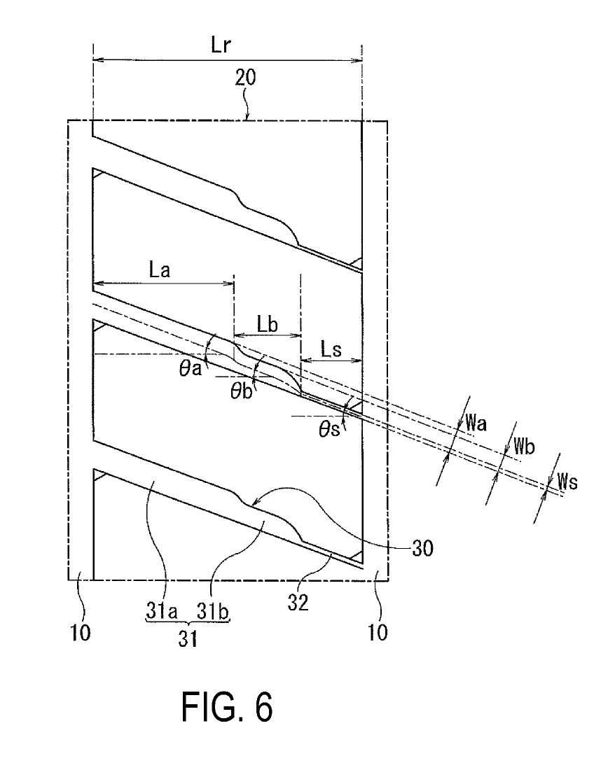

According to the present technology, the areas of the land portions 20 in which rigidity decreases as a result of the lateral grooves 31 need to be distributed in the tire width direction by disposing the plurality of compound grooves 30 so that the opening direction of the lateral grooves 31 with respect to the main groove 10 alternatingly reverses in the tire circumferential direction, as described above. When all of the lateral grooves 31 formed in one row of the land portion 20 open to the main groove 10 on the same side as illustrated in FIG. 6, for example, the rigidity of the land portion 20 on one side in the tire width direction significantly decreases locally more than other areas, making uneven wear more likely to occur.

As described above, good snow performance and wear resistance performance can be achieved in a well-balanced manner by setting the ratios Wa/Wb and Wb/Ws of the groove widths of each portion within a predetermined range as described above. When the groove widths Wa, Wb, Ws deviate from the range described above, the balance in groove width change of the compound groove 30 deteriorates, making it difficult to achieve good snow performance and wear resistance performance in a well-balanced manner. Specifically, when the ratio Wa/Wb of the groove width Wa to the groove width Wb is less than 1.2, the change in groove width of the lateral groove 31 decreases, causing the lateral groove 31 to have a substantially constant groove width as a whole, and thus making it no longer possible to achieve the effect of improving wear resistance performance. When the ratio Wa/Wb of the groove width Wa to the groove width Wb is greater than 3.0, the difference in the groove widths of the broad width portion 31a and the narrow width portion 31b is too large, making it difficult to achieve good snow performance and wear resistance performance in a compatible manner. When the ratio Wb/Ws of the groove width Wb to the groove width Ws is less than 1.2, the groove width of the narrow width portion 31b is too small, causing the narrow width portion 31b to have substantially the same width as that of the sipe 32, and thus decreasing snow performance. When the ratio Wb/Ws of the groove width Wb to the groove width Ws is greater than 5.0, the groove width of the narrow width portion 31b is too large, decreasing land portion rigidity and deteriorating wear resistance performance.

Moreover, when the length in the circumferential direction (pitch length) of the portion of the land portion 20 defined by the compound grooves 30 changes, the groove width of the compound groove 30 adjacent to the portion of the land portion 20 having a large pitch length is preferably greater than the groove width of the compound groove 30 adjacent to the portion of the land portion 20 having a small pitch length in order to efficiently secure drainage performance and achieve a favorable rigidity balance. However, even when the groove width thus differs according to the compound groove 30, the groove widths Wa, Wb, Ws of each portion satisfy the ranges of the ratio Wa/Wb and the ratio Wb/Ws described above. More preferably, the ratio Wa/Wb is set within a range of from 1.2 to 2.0, regardless of pitch length, and the ratio Wb/Ws is set to within a range of from 2.0 to 3.0 in the portion of the land portion 20 having the largest pitch length and to within a range of from 1.3 to 2.3 in the portion of the land portion 20 having the smallest pitch length.

While the inclination direction of the compound grooves 30 formed in the central land portion 21 and the inclination direction of the compound grooves 30 formed in the intermediate land portions 22 differ from each other in the embodiment in FIG. 2, at least the inclination direction of the compound grooves 30 formed in any one of the land portions 20 (the central land portion 21 and the intermediate land portions 22 positioned in the center region Ce) is opposite to the inclination direction of the compound grooves 30 formed in the other land portions 20. With the inclination directions of the compound grooves 30 differing in this way, the direction heteroscedasticity during steering decreases, strengthening the improvement in snow performance. In particular, when the pneumatic tire has three rows of land portions (one row of the intermediate land portion on each side of one row of the central land portion 21) as in the embodiment illustrated in FIG. 2, the inclination direction of the compound grooves 30 formed in the land portions 20 adjacent in the tire width direction is alternately set by differing the inclination direction of the compound grooves 30 formed in the central land portion 21 from the inclination direction of the compound grooves 30 formed in the intermediate land portions 22 as described above, thereby making it possible to effectively exhibit the effect of improving snow performance described above.

The tire width direction lengths La, Lb, Ls of each portion of the compound groove 30 are set within the above-described ranges with respect to the width Lr of the land portions 20 in which the compound grooves 30 are formed, making it possible to appropriately secure the lengths of the narrow width portion 31b and the sipe 32 while adequately securing the broad width portion 31a that contributes to snow performance, thereby strengthening the achievement of good snow performance and wear resistance performance in a well-balanced manner. At this time, when the ratio La/Lr is less than 0.4, the percentage of the broad width portion 31a that occupies the compound groove 30 decreases, making it difficult to adequately achieve good snow performance. When the ratio La/Lr is greater than 0.7, the percentage of the broad width portion 31a that occupies the compound groove 30 decreases, making it difficult to adequately maintain land portion rigidity and achieve excellent wear resistance performance. When the ratio Lb/Lr is less than 0.15, the narrow width portion 31b becomes substantially nonexistent, making the configuration substantially the same as when the sipe 32 is directly connected to the broad width portion 31a. As a result, the change in groove width from the lateral groove 31 to the sipe 32 becomes abrupt, making it difficult to adequately improve wear resistance performance. When the ratio Lb/Lr is greater than 0.3, the narrow width portion 31b is too large, making it difficult to adequately secure the length of the broad width portion 31a, and thus adequately achieve good snow performance. When the ratio Ls/Lr is less than 0.15, the length of the lateral groove 31 is too large, making it difficult to adequately maintain land portion rigidity and thus achieve excellent wear resistance performance. When the ratio Ls/Lr is greater than 0.3, it is difficult to adequately secure the length of the lateral groove 31 and thus achieve excellent snow performance.

While the tire width direction length Lb of the narrow width portion 31b and the tire width direction length Ls of the sipe 32 may differ, the tire width direction lengths Lb, Ls are preferably substantially the same. For example, the ratio Lb/Ls of the length Lb to the length Ls may be within a range of from 0.8 to 1.2.

While the compound grooves 30 are formed in the one row of the central land portion 21 and each of the rows of the intermediate land portion 22 disposed on both sides in the tire width direction thereof (that is, all land portions 20 positioned inside the center region Ce) in the embodiment illustrated in FIG. 2, the above-described effect of achieving good snow performance and wear resistance performance in a compatible manner can be achieved as long as the compound grooves 30 are provided to at least one of these land portions 20. The effect achieved from the compound grooves 30 increases in proportion to the number of land portions 20 among these land portions 20 (all land portions 20 positioned inside the center region Ce) in which the compound grooves 30 are formed, making it possible to more efficiently achieve good snow performance and wear resistance performance in a compatible manner.

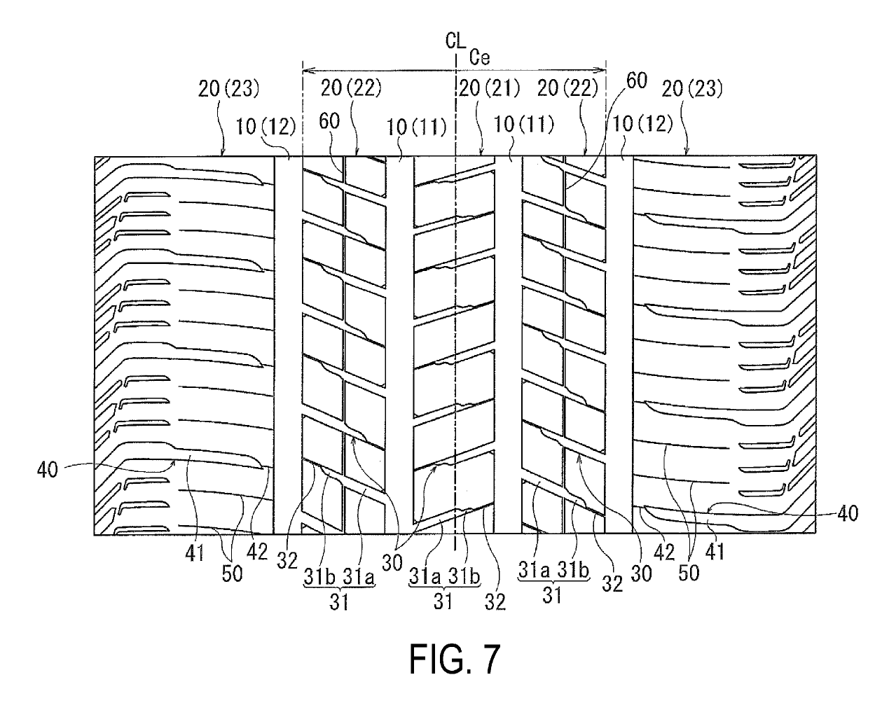

The land portions in which the compound grooves 30 are formed may be further provided with a circumferential-direction auxiliary groove 60 having a smaller groove width than that of the main grooves 10 and extending in the tire circumferential direction, as illustrated in FIG. 7. Examples of such a circumferential-direction auxiliary groove 60 include a narrow groove having a groove width of 3 mm or less, and a sipe having a groove width of 1.5 mm or less. With the circumferential-direction auxiliary groove 60 thus provided, edge components resulting from the circumferential-direction auxiliary groove 60 are also obtained, making it possible to further improve snow performance.

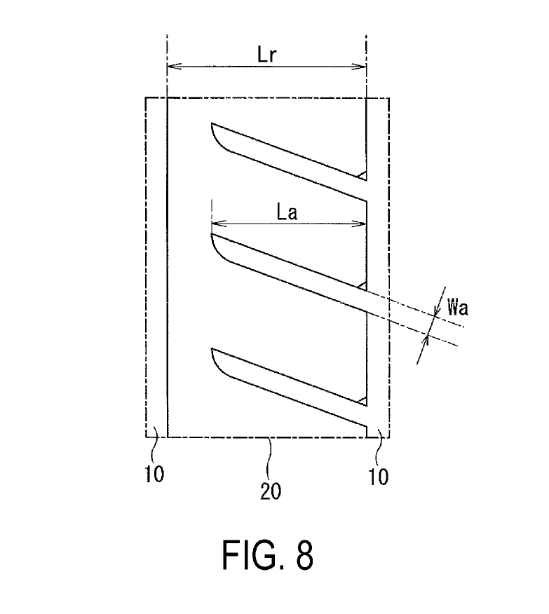

At this time, the circumferential-direction auxiliary groove 60 may be provided to all land portions 20 in which the compound grooves 30 are formed, but is preferably provided in a limited way to only the intermediate land portions 22 on both sides in the tire width direction as illustrated in FIG. 8, for example. With the circumferential narrow groove 60 disposed in a limited way and not included in the central land portion 21, block rigidity is secured, strengthening the improvement in wear resistance and steering stability.

While the circumferential-direction auxiliary grooves 60 may be provided so as to intersect the compound grooves 30 and continue in the tire circumferential direction as illustrated in FIG. 7, the circumferential-direction auxiliary grooves 60 that are positioned between adjacent compound grooves 30 and do not reach the compound grooves 30 may be disposed on the same line extending in the tire circumferential direction.

The circumferential-direction auxiliary grooves 60 are preferably provided to a central portion in the width direction of the land portions 20 in which the compound grooves 30 are formed, and may be disposed, for example, in a region from one width-direction end portion of the land portion 20 in which the compound grooves 30 are formed to a region of from 30% to 70% of the width Lr of this land portion 20. More preferably, the circumferential-direction auxiliary grooves 60 are disposed in a region from one end portion in the width direction of the land portion 20 in which the compound grooves 30 are formed to a region of from 40% to 60% of the width Lr of this land portion 20. With the circumferential-direction auxiliary grooves 60 disposed in such positions, it is possible to achieve excellent uneven wear resistance performance.

### EXAMPLES

As Conventional Example 1, Comparative Examples 1 and 2, and Examples 1 to 11, fourteen types of pneumatic tires were produced using tires having a tire size of 215/60R16, the reinforcement structure illustrated in FIG. 1, and the tread pattern illustrated in FIG. 2 excluding the compound grooves (and the circumferential-direction auxiliary grooves), as bases. The structure of the compound grooves, the relationship of the inclination directions of the compound grooves in the central land portion and the compound grooves in the intermediate land portions, the groove width ratios (ratio Wa/Wb and ratio Wb/Ws) of the compound grooves, the groove length ratios (ratio La/Lr, ratio Lb/Lr, and ratio Ls/Lr), the presence/absence of the circumferential narrow grooves, and the groove width of the circumferential narrow grooves were set as indicated in Table 1.

In these 14 types of pneumatic tires, the shape of the compound groove is common to that illustrated in FIG. 2, excluding in Conventional Example 1, Comparative Examples 1 and 2, and Example 4. That is, each of the compound grooves includes a lateral groove having a first end that communicates with a main groove on one side thereof and a second end that terminates inside a land portion, and further includes a sipe that extends from the second end of this lateral groove to a main groove on the other side thereof. The lateral groove includes a broad width portion and a narrow width portion. Further, the compound grooves are disposed so that the opening direction of the lateral grooves with respect to the main grooves alternatingly reverses in the tire circumferential direction.

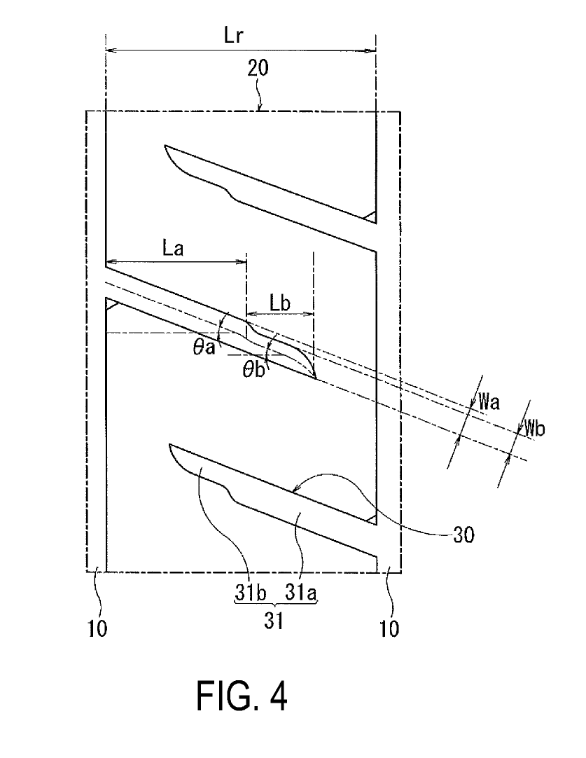

In contrast, Conventional Example 1 is an example that includes grooves having the shape illustrated in FIG. 8, and serves as an example in which lateral grooves are provided that extend at a constant width from the opening portion and terminate inside the land portion, and all lateral grooves open to a main groove on the same side. While the grooves, without sipes, cannot be called compound grooves, the figure number is stated in the “Structure of compound groove” row of Table 1 for the sake of convenience. Further, the groove, as a whole, forms a broad width portion, and therefore only the ratio La/Lr is stated. Comparative Example 1 is an example that includes grooves having the shape illustrated in FIG. 6, and serves as an example in which the compound grooves, each formed by a sipe and a lateral groove that includes a broad width portion and a narrow width portion, open to a main groove on the same side. Comparative Example 2 is an example that includes grooves having the shape illustrated in FIG. 4, and serves as an example in which only lateral grooves including the broad width portion and the narrow width portion are formed, and sipes are not included. In this example, the opening direction of the lateral grooves with respect to the main grooves alternatingly reverses in the tire circumferential direction. While the grooves, without sipes, cannot be called compound grooves, the figure number is stated in the “Structure of compound groove” row of Table 1 for the sake of convenience. Further, because a sipe is not provided, only the ratio Wa/Wb, the ratio La/Lr, and the ratio Lb/Lr are stated.

Example 2 is an example in which the structure of the compound groove differs between the central land portion and the intermediate land portions. In this example, the lateral groove of the compound grooves formed in the central land portion includes the broad width portion and the narrow width portion, but the lateral groove of the compound grooves formed in the intermediate land portions is formed by the broad width portion only. In each area in Table 1 related to compound groove dimensions, the dimension is stated as “value of compound groove formed in central land portion/value of compound groove formed in intermediate land portions.”

Moreover, in each example, the groove width of the sipe was commonly set to 1.0 mm. Further, the width of the land portions in which the compound grooves are formed was commonly set to 24 mm.

These 14 types of pneumatic tires were evaluated for snow performance and wear resistance performance by the evaluation methods described below, and the results are also shown in Table 1.

### Snow Performance

The test tires were assembled on wheels with a rim size of 16×6.5 J, inflated to an air pressure of 240 kPa, mounted on a test vehicle having an engine displacement of 2.5 L, and subjected to a sensory evaluation for steering stability performance by the implementation of a test run by test drivers on a test course with a snowy road surface. Evaluation results were expressed as index values, with Conventional Example 1 being assigned a reference index value of 100. Larger index values indicate superior snow performance.

### Wear Resistance Performance

Each type of test tire was assembled on wheels with a rim size of 16×6.5 J, inflated to an air pressure of 240 kPa, and mounted on a test vehicle having an engine displacement of 2.5 L. The amount of wear was measured after driving 20000 km on a public road. The evaluation results were expressed as index values using the inverse value as the measurement value, and Conventional Example 1 being defined as 100. Larger index values indicate less amount of wear and superior wear resistance performance.

TABLE 1

| | | Conventional | Comparative | Comparative | Example | Example | Example | Example |
|---|---|---|---|---|---|---|---|---|
| | | Example 1 | Example 1 | Example 2 | 1 | 2 | 3 | 4 |
| Structure of compound | | FIG. 8 | FIG. 6 | FIG. 4 | FIG. 3 | FIG. 3 | FIG. 3 | FIG. 3 |
| groove | | | | | | | | |
| Relationship of inclination | | Opposite | Opposite | Opposite | Opposite | Opposite | Same | Opposite |
| directions of compound | | | | | | | | |
| grooves | | | | | | | | |
| Groove width | Wa/Wb | — | 4.0 | 4.0 | 4.0 | 4.0/— | 4.0 | 4.0 |
| ratio | Wb/Ws | — | 7.0 | 7.0 | 7.0 | 7.0/— | 7.0 | 7.0 |
| Groove length | La/Lr | 0.66 | 0.33 | 0.33 | 0.33 | 0.33/0.66 | 0.33 | 0.33 |
| ratio | Lb/Lr | — | 0.33 | 0.33 | 0.33 | 0.33/— | 0.33 | 0.33 |
| | Ls/Lr | — | 0.33 | 0.33 | 0.33 | 0.33/0.33 | 0.33 | 0.33 |
| Presence/absence of | | Absent | Absent | Absent | Absent | Absent | Absent | Present |
| circumferential-direction | | | | | | | | |
| auxiliary groove | | | | | | | | |
| Groove width of | mm | — | — | — | — | — | — | 0.2 |
| circumferential- | | | | | | | | |
| direction auxiliary | | | | | | | | |
| groove | | | | | | | | |
| Snow performance | Index | 100 | 103 | 95 | 106 | 102 | 104 | 108 |
| | value | | | | | | | |
| Wear resistance | Index | 100 | 97 | 103 | 104 | 102 | 104 | 103 |
| performance | value | | | | | | | |
| | | Example | Example | Example | Example | Example | Example | Example |
| | | 5 | 6 | 7 | 8 | 9 | 10 | 11 |
| Structure of compound | | FIG. 3 | FIG. 3 | FIG. 3 | FIG. 3 | FIG. 3 | FIG. 3 | FIG. 3 |
| groove | | | | | | | | |
| Relationship of inclination | | Opposite | Opposite | Opposite | Opposite | Opposite | Opposite | Opposite |
| directions of compound | | | | | | | | |
| grooves | | | | | | | | |
| Groove width | Wa/Wb | 4.0 | 1.2 | 2.0 | 3.0 | 2.0 | 2.0 | 2.0 |
| ratio | Wb/Ws | 7.0 | 1.2 | 2.0 | 5.0 | 2.0 | 2.0 | 2.0 |
| Groove length | La/Lr | 0.33 | 0.33 | 0.33 | 0.33 | 0.4 | 0.6 | 0.7 |
| ratio | Lb/Lr | 0.33 | 0.33 | 0.33 | 0.33 | 0.3 | 0.2 | 0.15 |
| | Ls/Lr | 0.33 | 0.33 | 0.33 | 0.33 | 0.3 | 0.2 | 0.15 |
| Presence/absence of | | Present | Present | Present | Present | Present | Present | Present |
| circumferential-direction | | | | | | | | |
| auxiliary groove | | | | | | | | |
| Groove width of | mm | 0.3 | 0.2 | 0.2 | 0.2 | 0.2 | 0.2 | 0.2 |
| circumferential- | | | | | | | | |
| direction | | | | | | | | |
| auxiliary groove | | | | | | | | |
| Snow performance | Index | 107 | 108 | 109 | 108 | 110 | 111 | 110 |
| | value | | | | | | | |
| Wear resistance | Index | 102 | 104 | 105 | 104 | 104 | 105 | 104 |
| performance | value | | | | | | | |

As understood from Table 1, Examples 1 to 11 each exhibited snow performance and wear resistance performance in a well-balanced manner, showing improvements from Conventional Example 1. On the other hand, Comparative Example 1, in which all compound grooves open to a main groove on one side thereof only, deteriorated in wear resistance performance. Comparative Example 2, in which sipes are not provided, deteriorated in snow performance. Comparative Example 3, in which the groove width ratio does not satisfy the range of the present technology, deteriorated in wear resistance performance.

1. A pneumatic tire, comprising:
four main grooves that extend in a tire circumferential direction on a tread portion; and
five rows of land portions defined by the four main grooves, wherein
among the four main grooves, the main grooves disposed on sides of a tire equator are inner main grooves, the main grooves disposed on an outer side in a tire width direction of the inner main grooves are outer main grooves,
a land portion positioned between the inner main grooves is a central land portion, the land portions positioned between the inner main groove and the outer main grooves are intermediate land portions, and the land portions positioned on an outer side in the tire width direction of the outer main grooves are outer land portions,
a plurality of compound grooves, each including a lateral groove having a first end that communicates with a first main groove and a second end that terminates inside a land portion, and further including a sipe that extends from the second end of the lateral groove to a second main groove, are formed at an interval in the tire circumferential direction in the central land portion or at least one of the intermediate land portions,
the compound grooves are disposed so that an opening direction of the lateral grooves relative to the main grooves alternatingly reverses in the tire circumferential direction, and
the lateral grooves each include a broad width portion that opens to a main groove and extends at a constant groove width, and a narrow width portion that is positioned between the broad width portion and the sipe and extends at a constant groove width narrower than that of the broad width portion.

2. The pneumatic tire according to claim 1, wherein the compound grooves are formed in the central land portion as well as each of the intermediate land portions.

3. The pneumatic tire according to claim 2, wherein an inclination direction of the plurality of compound grooves formed in any one of the central land portion or the intermediate land portions differs from an inclination direction of the plurality of compound grooves formed in another of the central land portion or the intermediate land portions.

4. The pneumatic tire according to claim 3, wherein the inclination direction of the compound grooves differs between the central land portion and the intermediate land portions.

5. The pneumatic tire according to claim 1, wherein a circumferential-direction auxiliary groove having a groove width that is smaller than that of the main grooves and extending in the tire circumferential direction is provided to at least one of the land portions having the compound grooves formed therein.

6. The pneumatic tire according to claim 1, wherein a ratio Wa/Wb of a groove width Wa of the broad width portion to a groove width Wb of the narrow width portion is within a range of from 1.2 to 3.0, and a ratio Wb/Ws of the groove width Wb of the narrow width portion to a groove width Ws of the sipe is within a range of from 1.2 to 5.0.

7. The pneumatic tire according to claim 1, wherein a ratio La/Lr of a width Lr of a land portion having the compound grooves formed therein to a tire width direction length La of the broad width portion satisfies a relationship 0.4≦La/Lr≦0.7, a ratio Lb/Lr of the width Lr to a tire width direction length Lb of the narrow width portion satisfies a relationship 0.15≦Lb/Lr≦0.3, and a ratio Ls/Lr of the width Lr to a tire width direction length Ls of the sipe satisfies a relationship 0.15≦Ls/Lr≦0.3.

8. The pneumatic tire according to claim 2, wherein a circumferential-direction auxiliary groove having a groove width that is smaller than that of the main grooves and extending in the tire circumferential direction is provided to at least one of the land portions having the compound grooves formed therein.

9. The pneumatic tire according to claim 8, wherein a ratio Wa/Wb of a groove width Wa of the broad width portion to a groove width Wb of the narrow width portion is within a range of from 1.2 to 3.0, and a ratio Wb/Ws of the groove width Wb of the narrow width portion to a groove width Ws of the sipe is within a range of from 1.2 to 5.0.

10. The pneumatic tire according to claim 9, wherein a ratio La/Lr of a width Lr of a land portion having the compound grooves formed therein to a tire width direction length La of the broad width portion satisfies a relationship 0.4≦La/Lr≦0.7, a ratio Lb/Lr of the width Lr to a tire width direction length Lb of the narrow width portion satisfies a relationship 0.15≦Lb/Lr≦0.3, and a ratio Ls/Lr of the width Lr to a tire width direction length Ls of the sipe satisfies a relationship 0.15≦Ls/Lr≦0.3.
